(19) United States
(12) Patent Application Publication
(10) Pub. No.: US 2022/0228032 A1
(43) Pub. Date: Jul. 21, 2022

(54) BREAKAWAY ADHESIVE COATING SYSTEM

(71) Applicant: McAuliffe Paper Inc., Liverpool, NY (US)

(72) Inventors: William R. Krahl, Baldwinsville, NY (US); Charles Thiaville, Manlius, NY (US); David K. Holbrook, Syracuse, NY (US)

(21) Appl. No.: 17/579,114

(22) Filed: Jan. 19, 2022

Related U.S. Application Data
(60) Provisional application No. 63/139,357, filed on Jan. 20, 2021.

(51) Int. Cl. C09J 5/02; C09J 9/00; C09J 133/08; B65D 5/70

(52) U.S. Cl. CPC C09J 5/02; B65D 5/708; C09J 133/08; C09J 9/00

(57) ABSTRACT

A breakaway adhesive coating system includes a substrate having a first substrate surface and a second substrate surface. A release coating is disposed over at least a portion of and bonded to the second substrate surface. A breakaway coating is disposed over a release coating surface opposite to the second substrate surface, the breakaway coating bonded to the release coating. An adhesive layer is disposed over a breakaway coating surface opposite to the release coating, the adhesive layer bonded to the breakaway coating.

### CROSS-REFERENCE TO RELATED APPLICATIONS

This application claims priority to and the benefit of co-pending U.S. provisional patent application Ser. No. 63/139,357, BREAKAWAY ADHESIVE COATING SYSTEM, filed Jan. 20, 2021, which application is incorporated herein by reference in its entirety.

### FIELD OF THE APPLICATION

The application relates to labels, sheets, or tapes, particularly labels, sheets, or tapes which show evidence of tamper.

### BACKGROUND

Tapes, sheets, labels, etc. are often made with an adhesive layer to affix to a surface. Some of these products provide a tamper resistant system, where, for example, when a label is removed from a surface, the label tears, or patches of label are left behind. Some tamper resistant systems are actually multi-ply systems where two or more tapes or labels are affixed to the surface, and pulling off the tape or label, removes the topmost tape or label, leaving behind another complete label system. Such multi-ply systems are relatively difficult and costly to manufacture. For example, one such system made from two or more layers of a film tape can cost an order of magnitude or more, than the cost of a typical single ply paper tape.

### SUMMARY

A breakaway adhesive coating system includes a substrate having a first substrate surface and a second substrate surface. A release coating is disposed over at least a portion of and bonded to the second substrate surface. A breakaway coating is disposed over a release coating surface opposite to the second substrate surface, the breakaway coating bonded to the release coating. An adhesive layer is disposed over a breakaway coating surface opposite to the release coating, the adhesive layer bonded to the breakaway coating.

After the adhesive layer is affixed to a surface, a removal force applied to the breakaway adhesive coating system causes a bond between the release coating and the breakaway coating to break, wherein a first combination of the substrate and the release coating pull free of a second combination of the breakaway coating and the adhesive layer which remain affixed to the surface.

Following separation of the first combination of the substrate and the release coating and the second combination of the breakaway coating and the adhesive layer, both exposed surfaces of the release coating and the breakaway coating have substantially no tackiness.

The breakaway adhesive coating system can include a label. The breakaway adhesive coating system can include a sheet. The breakaway adhesive coating system can include a tape.

The tape can include a rolled linered tape. The tape can include a rolled linerless tape. The tape can include a point of sale register tape.

The breakaway adhesive coating system can further include one or more print layers disposed on the first substrate surface. At least one print layer can include a thermosensitive print layer.

The substrate can include a paper or a film.

The release coating can include a vinyl acrylic copolymer emulsion.

The breakaway coating can include a styrene-acrylic emulsion.

The adhesive layer can include an acrylic emulsion. The adhesive layer can include a dry adhesive. The dry adhesive can include a moisture activated adhesive.

During manufacture of the breakaway adhesive coating system, at least of one of the release coating or the breakaway coating is applied wet and a bond formed there between during drying.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A is a drawing showing a side view of an exemplary tape, label, sheet, etc. according to the new breakaway adhesive coating system of the Application;

FIG. 1B is a drawing showing a side view of the single ply tape, label, sheet, etc. of FIG. 1A affixed to any suitable surface;

FIG. 1C is a drawing showing the exemplary single ply tape, label, sheet, etc. of the breakaway adhesive coating system structure of FIG. 1A being removed in part or in whole from the use surface;

FIG. 2 is a drawing showing an exemplary tape, label, sheet, etc. of the breakaway adhesive coating system structure with a print coating on the substrate the top surface of the substrate:

FIG. 3 is a drawing showing an exemplary breakaway adhesive coating system of the Application including a linerless release coating disposed over the substrate;

FIG. 4 is a drawing showing an exemplary breakaway adhesive coating system of the Application including a linerless release coating disposed over a print coating;

FIG. 5A is a drawing of an exemplary printed tape;

FIG. 5B is a drawing of a paper bag, where following opening the bag the combined top part has separated from the combined bottom part;

FIG. 6A is a drawing showing an exemplary food box secured closed by a tape or label of the breakaway adhesive coating system of the Application; and

FIG. 6B is a drawing showing separation on opening between the combined top part which has separated from the combined bottom part.

### DETAILED DESCRIPTION

As described hereinabove, tapes, sheets, labels, etc. are often made with an adhesive layer to affix to a surface. Some of these products provide a tamper resistant system, where, for example, when a label is removed from a surface, the label tears, or patches of label are left behind. Some tamper resistant systems are actually multi-ply systems where two or more tapes or labels are affixed to the surface, and pulling off the tape or label, removes the topmost tape or label, leaving behind another complete label system. Such multi-ply systems are relatively difficult and costly to manufacture. For example, one such system made from two or more layers of a film tape can cost an order of magnitude or more, than the cost of a typical single ply paper tape.

What is needed is a relatively low cost single ply breakaway adhesive coating system which shows evidence of tamper and which retains no tackiness after its bonds are broken so that layers cannot simply be reassembled following a tamper event.

In describing structures of the breakaway adhesive coating system of the application, phrases such as top, bottom, side, under, over, are used for convenience. However, it is understood that top does require any particular direction or orientation, such as up. Generally, for convenience, top is either what is viewed by an observer, or a surface of a layer or part in the direction towards what is viewed by an observer, while bottom is either the bottom of the adhesive affixed to a surface, or the side of a part or layer in the direction of the adhesive. Side, at least with respect to side views, is generally used as a section view (including cross section) of the layered structure including a substrate, coating layers, and an adhesive layer.

Security tapes, labels, sheets, etc. provide an indication of tamper. Tamper evidence ranges from changes in the look of the tampered visible parts, to leaving behind some portion of residue, or a second label from a stack of labels.

What is needed is a cost efficient relatively simple single ply breakaway system structure where once removed, the portion removed can no longer be replaced to look like the original structure.

This Application describes a new breakaway adhesive coating system. It was realized that a single ply tape, sheet, label, etc. can be manufactured which applies in use in the common ways by an adhesive layer affixed to a surface, however on tamper, a manufactured one-time bond between two internal layers severs, comes apart, and no longer retains tackiness. Thus, once the bond between an internal release coating and breakaway coating is broken, the single ply tape, sheet, label, etc. cannot be reassembled.

The breakaway adhesive coating system of the Application is suitable for use in labels, tapes, sheets, etc. Another use where relatively low cost is important is for printer tapes, such as point of sale (POS) printer tapes, such as in fast food use, where the receipt tape can also serve as a security tape for the box and/or bag which holds food for delivery, such as delivery by a third party driver.

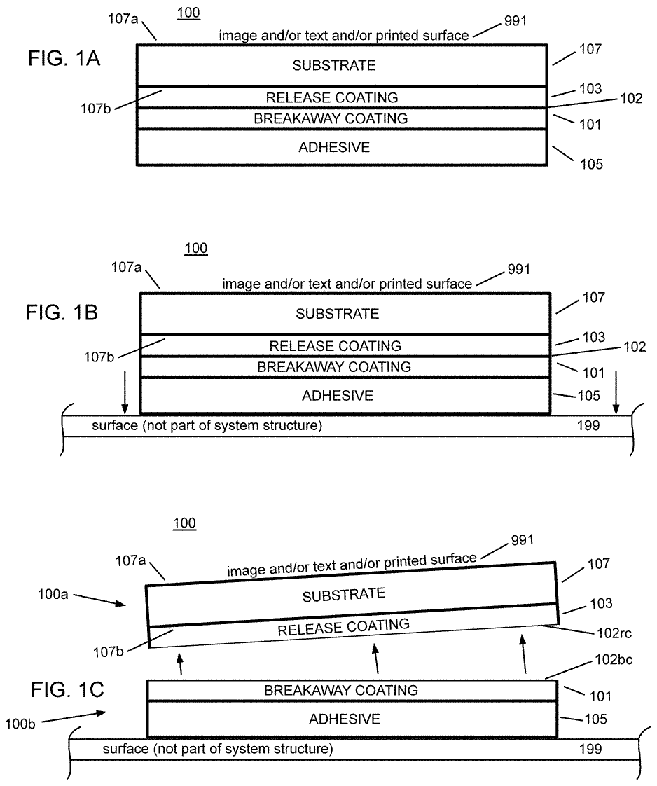

FIG. 1A to FIG. 1C show an exemplary breakaway adhesive coating system structure before and after breakaway. It is understood that the adhesive part is affixed to a surface, which is not part of the system structure. Generally, the exemplary breakaway adhesive coating system structure is a 1 ply system. A tape, label, sheet, etc. is provided as a single ply. The tape, label, sheet, etc. can be provided as a linered structure (where a liner over the adhesive side is peeled away before use), or as a linerless structure, such as a wound tape, where the adhesive is exposed on unwinding (e.g., printing a tape in a register). It is unimportant whether the tape, label, sheet, etc. is a linered or linerless part.

FIG. 1A is a drawing showing a side view of an exemplary part 100 (e.g., a tape, label, sheet, etc.) according to the new breakaway adhesive coating system of the Application. FIG. 1B is a drawing showing a side view of the single ply tape, label, sheet, etc. is affixed to any suitable surface (the surface is not part of the breakaway adhesive coating system structure) as any other adhesive tape, label, sheet, etc. is affixed to a surface. FIG. 1C shows how following a tamper force to pull the tape, label, sheet, etc. from the surface, the tape, label, sheet, etc. separates at the boundary 102 between release coating 103 and breakaway coating 101. Following separation, the adhesive 105 remains intact and affixed to the surface. The top of the breakaway coating, however, is not sticky, and substantially without tackiness, the substrate 107 and release coating 103 cannot be re-attached to the breakaway coating 101. The single ply breakaway adhesive coating system of the Application is a one-time use part. Once separated at boundary 102, between the bottom surface 102rc of the release coating and the top surface 102bc of the breakaway coating 101, the tape, label, sheet, etc. is permanently separated, and not re-usable.

As shown in FIG. 1A, there is a single ply tape, label, sheet, etc. of the breakaway adhesive coating system structure 100. Substrate 107 includes a first substrate side, referred to for convenience, as the substrate top side 107a, and a second substrate side, referred to for convenience, as the bottom substrate side 107b.

One example of a suitable release coating 103 includes a vinyl acrylic copolymer emulsion (hydrophobic) with a solids content of about 39-41%, about 59-61% water, and about 39-41% polymer. One example of a suitable breakaway coating 101 includes a styrene-acrylic emulsion with a solids content of about 47-49%, less than 0.2% Ammonium Hydroxide, ACS, about 45-60% water, and about 40-55% polymer. One example of a suitable adhesive 105 includes a high solids acrylic emulsion with about 69-71% solids, acrylic polymer, with about 30% by weight water and about 70% by weight acrylic co-polymer (such as, for example, a 2-Propenoic acid, 2-methyl-, methyl ester, polymer with 2-ethylhexyl 2-propenoate, ethyl 2-propenoate and 2-propenoic acid).

There can be text and/or images 991 printed or transferred to the substrate top side 107a either directly to the substrate surface, or as described in more detail hereinbelow via an additional thermal print layer, thermal transfer layer, etc. The substrate top side 107a can also be devoid of print or images and be white or of any suitable color.

Moreover, and also as described hereinbelow in more detail, either directly on top of the substrate surface 107a, or as described later, on top of one or more print layers and/or coatings, there can be an additional liner release coat in the case of a linered label. A liner release coat or layer should not be confused with the release coating 103 of FIG. 1A to FIG. 1C.

FIG. 1B is a drawing showing the exemplary single ply tape, label, sheet, etc. of the breakaway adhesive coating system structure 100 of FIG. 1A attached to a use surface 199 which is not part of the system structure. The single ply tape, label, sheet, etc. is affixed to the use surface 199 by adhesive 105.

FIG. 1C is a drawing showing the exemplary single ply tape, label, sheet, etc. of the breakaway adhesive coating system structure 100 of FIG. 1A being removed in part or in whole from the use surface 199.

When a force is applied, such as pulling at the tape, label, sheet, etc., the breakaway adhesive coating system structure 100 separates at the boundary 102 between the release coating 103 and the breakaway coating 101. The combined top part 100a which includes substrate 107 and release coating 103, comes off exposing the combined bottom part 100b, which includes release coating lower surface 102rc. The combined adhesive 105 and breakaway coating 101 remain affixed to the user surface 199. The combined top part 100a separates from the combined bottom part 100b because the adhesive force affixing the combined bottom part 100b to the user substrate 199 is greater than the holding force or adhesion between the release coating lower surface 102rc and the breakaway coating top surface 102bc. Once so separated, there remains substantially no tackiness on either of the combined top part 100a or combined bottom part 100b, and once separated from the combined bottom part 100b, the now separated combined top part 100a cannot be reattached.

Moreover, the surface properties of the now exposed breakaway coating top surface 102bc are so repellant to acceptance of any material, the breakaway coating top surface 102bc can substantially repel and not accept many forms of writing as well as any attempt to apply a new layer of glue or adhesive, such as from a glue pen, etc.

As described hereinbelow in more detail, there can be a message and/or image either on top of the adhesive 105 viewable through the breakaway coating, or on the breakaway coating top surface 102bc, such as “VOID”, tampered, etc. There can also, or alternatively, be a message and/or image on the user surface 199 viewable post separation where the adhesive 105 and breakaway coating 101 are translucent or transparent.

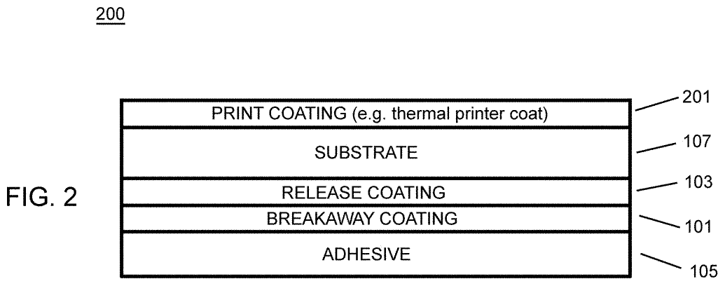

FIG. 2 is a drawing showing an exemplary tape, label, sheet, etc. of the breakaway adhesive coating system structure with a print coating on the substrate top surface 107a. The print coating 201 can be any suitable coating to facilitate printing and/or transfer of text and/or images to the viewable surface of the tape, label, sheet, etc. of the breakaway adhesive coating system structure. For example, print coating 201 can be a thermal print coating for a POS thermal printer. Or, print coating 201 can be a coating to enhance a transfer, such as a thermal transfer of an image and/or printing to the top surface of the printed tape, label, sheet, etc. Moreover, there can be any suitable typically protective coating over the print coating 201 (not shown in FIG. 2).

The breakaway adhesive coating system of the Application can be provided in a linerless version, such as, for example, for a linerless printer roll. Without a liner to separate each layer, e.g., each wind in a linerless printer roll, there can be a linerless release coating disposed over the topmost coating, typically the top of the substrate, or a print coating over the top of the substrate. There can optionally be additional coatings over a printer coating.

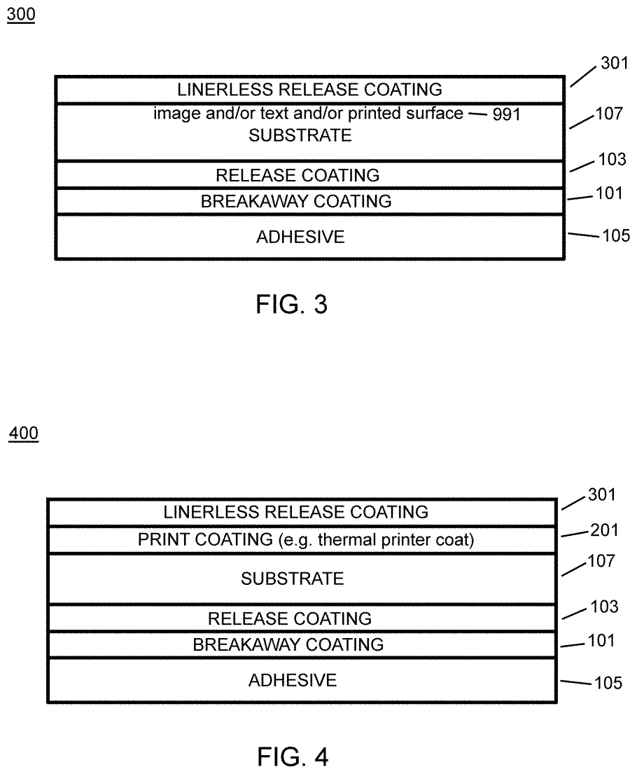

FIG. 3 is a drawing showing an exemplary breakaway adhesive coating system of the Application including a linerless release coating 301 disposed over a substrate 107. FIG. 4 is a drawing showing an exemplary breakaway adhesive coating system of the Application including a linerless release coating 301 disposed over a print coating 201. The linerless release coating 301 is different from and should not be confused the release coating 103.

Turning back now to FIG. 1A, at time of manufacture, release coating 103 adheres to breakaway coating 101 and the two remain mechanically coupled unless and until the combined top part 100a is pulled off of a tape, label, or sheet affixed to a surface 199. At time of manufacture, release coating 103 is adhered to breakaway coating 101 by coating the back of the substrate surface 107b with the release coating 103 in a wet form. The breakaway coating can also be applied in a wet form. After production there will be a low surface energy between the release coating 103 and the breakaway coating 101.

Release Coating—The release coating can be a silicone or a non-silicone, water-based or a non-water-based coating. Release coatings have a relatively low surface energy. The release coating surface energy can vary in relationship to the strength of the adhesive being used for the breakaway adhesive coating.

Break Away Coating—The breakaway coating can be a water-based or a non-water-based coating. For example, the breakaway coating can be a non-tacky acrylic type coating.

Adhesive Layer—The adhesive layer can be silicone or non-silicone, water-based or non-water-based. For example, the adhesive layer can be a pressure sensitive adhesive type coating.

Exemplary adhesive peel adhesion forces—Exemplary adhesive peel adhesion forces can be about 0.5 oz./in. (14 grams/in.) to 100 oz./in. (2835 grams/in.). Testing has been done using a peel adhesion testing unit at a peel adhesion peel angle of 90 degrees or 180 degrees. The adhesive coated substrate was peeled from 304 stainless steel plates (304 stainless steel plates with a bright annealed finish. The contents of the stainless steel complied with the specifications required by ASTM A666). A 10 minute dwell time period was used. The peel rate was 12 in./min. (304.8 mm/min.).

The adhesive can also be a dry adhesive, including any suitable moisture activated adhesive. Moisture activated adhesives are activated by moisture, such as can be applied by any suitable wetting method from licking by tongue (as in sealing an envelope), to wetting by sponge (e.g. some manual dispensers), to wetting by rollers. In some applications, such as food service uses, there may be sufficient moisture generated by the typically hot food itself to wet a moisture activated adhesive.

Breakaway coating example—The breakaway force from release coating was about 0.25 oz./in. (7 grams/in.) to 50 oz./in. (1417.5 grams/in.). For peeling testing, the coated substrate (breakaway adhesive coating product) was attached to test panels using 2-side (double adhesion sided) high adhesion tape. The adhesive on the breakaway coating should anchor to the test panel with a permanent type bond so the breakaway force can be measured, as opposed to the peel adhesion force of the adhesive being used on the breakaway coating. Break away force can be measured, for example, using a peel adhesion testing unit at a peel adhesion peel angle of 90 degrees or 180 degrees. The coated substrate can be peeled from its mounted position on the test panel. For example, a 0 minute dwell time period with a peel rate of 12 in./min. (304.8 mm/min.) can be used.

Surface energy—For optimal adhesion, an adhesive or coating should thoroughly “wet out” the surface to be bonded. Wetting out means that the adhesive or coating flows and covers a surface to maximize the contact area where there are attractive forces between the adhesive or coating and the bonding surface. A low energy surface will be harder to bond to than a high energy surface (coating). Dried adhesives typically continue to wet out on the surface they are applied to over time, increasing the bond strength over time.

It is the drying of the breakaway coating 101 and the release coating 103 which provides the user tape, label, or sheet.

For example, a substrate can be coated with a wet release coating 103 as a step of manufacture, then a breakaway coating 101 can be wet coated over the release coating 103. Finally, the adhesive layer can be applied over the breakaway coating 101. When either or both of the release coating 103 and the breakaway coating 101 are so wet assembled and dried, there is a one-time adherence between the coatings which is set by drying, where the breakaway coating 101 becomes bonded to the release coating 103.

Post manufacture, when the combined top part 100a is pulled from the combined bottom part 100b there is no longer any tack, and to two parts can no longer be rejoined.

Once separated, either or both of the lower surface 102rc of the release coating and the upper surface of the breakaway coating can substantially not accept a glue (e.g., from a glue stick) and/or not accept most ink markings. Thus, further security is afforded, where the combined top part 100a can no longer be attached to the combined bottom part 100b, such as by adding another glue or adhesive. Also, the exposed surfaces substantially cannot be effectively marked. For example, attempted marking by pencil or pen might show pressure scoring marks, but little or no graphite, carbon, or ink would stick to the exposed surface.

Exemplary Product Description in summary, labels, sheets, or tapes can be constructed of paper or film substrates, coated with adhesive that will transfer to the surface the label, sheet, or tape applied to a surface. Upon removal of the label, sheet, or tape product, the label, sheet, or tape product will show that the label, sheet, or tape has been tampered with, or will be adhesive free upon removal, such as, for example, to store as a receipt for the customer's record keeping or later use or used as a coupon or informational/instructional note.

### Exemplary Construction

Label, sheet, or tape face (top side of the substrate): Linerless Release Coating, coated and dried, in the case of a self-wound roll product. The linerless release coating of the label, sheet, or tape face may not need to be release coated if a release liner is used to produce a linered end use label, sheet, or tape product.

Substrate: The substrate can be, for example, any suitable paper or film material. Exemplary suitable papers include coated or non-coated, offset paper, gloss paper, semi-gloss paper, kraft paper, vellum paper, bond paper, construction paper, direct thermal paper, thermal transfer paper, tissue paper, newsprint paper, cardboard paper, paperboard, fine art paper and any other suitable paper.

Exemplary suitable films include coated or non-coated, polypropylene film, high density polyethylene film, low density polyethylene film, blends of high and low density polyethylene film, polyester film, polyolefin film, blends of polymer film and other suitable film. The substrate can also be a layered substrate of two or more materials of the same or different types. For example, there can be two or more films of same or different type films. There can also be combinations of film or films and paper or paper layers.

Exemplary assembly where coatings under the substrate of FIG. 1A, are successively applied “over” each other to create the new structure of FIG. 1A.

Labels, sheets, or tapes back (back side of the substrate): release coating, coated and dried on the back side of the substrate.

Labels, sheets, or tapes back (back side of the substrate): break away coating, coated and dried on the release coating on the back side of the substrate.

Labels, sheets, or tapes back (back side of the substrate): adhesive coating, coated and dried on the breakaway coating on the back side of the substrate.

### Coatings Information

Label, sheet, or tape face (Top side of the substrate) exemplary linerless release coatings (e.g., 301, FIG. 3, FIG. 4):

Water-Based Silicones (Thermal Curable), 100% Solids Thermal Curable Silicones, Solvent Borne Silicones.

Solventless Silicones: Thermal Curable, Ultraviolet (UV) Curable (Silicone Acrylate Free Radical Mechanism and Epoxy Silicones using Cationic Initiators) and Electron Beam (EB) Curable Silicones.

Shellacs, Starch, Casein, Nitrocellulose, PVC Resin, Polyvinyl Butyral, Polyvinyl Alcohol, Vinyl Acetate Copolymer, Acrylic Resin, Polyvinyl Carbamates, Chromium Complexes (Chromium Complexes are attached to C14-C18 Fatty Acids), Fluorocarbon Copolymers, Amines (Long Chain Alkyl substituted Amines).

Long Chain Branched Polymers: (Waxy Compounds exhibiting good coating performance and release characteristics. Generally, Copolymers of Alkyl Acrylates and Acrylic Acid, Nitro Cellulose and Vinyl Chloride)

Waxes: Petroleum Waxes (such as, but not limited to: Paraffin Wax, Microcrystalline Wax), Vegetable Waxes (such as, but not limited to: Carnauba Wax), Animal Waxes (such as, but not limited to: Lanolin), Synthetic Waxes (such as, but not limited to: Polyethylene Wax, Polypropylene Wax)

Fatty Acid Metal Soaps: Metal Stearates (such as, but not limited to: Magnesium Stearate, Zinc Stearate), Calcium Ricinolate

Long Chain Alkyl Derivatives: Fatty Ester Synthetic Waxes (such as, but not limited to: Diethylene Glycol Monostearate, Hydrogenated Castor Oil), Fatty Acids (such as, but not limited to: Steric Acid, Oleic Acid), Fatty Amines (such as, but not limited to: EthyleneBis (Stearamide), Oleyl Palmitamide)

Natural Products: Cellulose Derivatives (such as, but not limited to: Cellophane, Cellulose Acetate), Polysaccharides (such as, but not limited to: Sodium Alginate)

Inorganic Materials: Silicates (such as, but not limited to: Talc), Clay (such as, but not limited to: Kaolin, Mica), Silica, Graphite

Synthetic Polymers: Silicones (such as, but not limited to: PolyDimethylsiloxane, PolyAlkylmerthyl Siloxane), Fluorocarbons (such as, but not limited to: PolyTetraFluoroethylene, Poly(Fluoroacrylates)), Fluoro Polmers (such as, but not limited to: Poly(Fluoroethers)), Polyolefins (such as, but not limited to: Polyethylene, Polypropylene), Polyvinyl Alcohol

Fluorinated Compounds: Fluorinated Fatty Acids and Alcohols (such as, but not limited to: Perfluorolauric Acid)

Vinyl Acrylic Copolymers, Acrylic Polymers and Copolymers, Polyvinyl Acetate Polymers and Copolymers, Styrene Acrylic Polymers and Copolymers, Polyurethane Dispersions

Labels, sheets or tapes back (back side of the substrate) exemplary release coating (e.g., 103, FIG. 1A):

Water-Based Silicones (Thermal Curable), 100% Solids Thermal Curable Silicones, Solvent Borne Silicones.

Solventless Silicones: Thermal Curable, Ultraviolet (UV) Curable (Silicone Acrylate Free Radical Mechanism and Epoxy Silicones using Cationic Initiators) and Electron Beam (EB) Curable Silicones.

Shellacs, Starch, Casein, Nitrocellulose, PVC Resin, Polyvinyl Butyral, Polyvinyl Alcohol, Vinyl Acetate Copolymer, Acrylic Resin, Polyvinyl Carbamates,

Chromium Complexes (Chromium Complexes are attached to C14-C18 Fatty Acids), Fluorocarbon Copolymers, Amines (Long Chain Alkyl substituted Amines).

Long Chain Branched Polymers: (Waxy Compounds exhibiting good coating performance and release characteristics. Generally, Copolymers of Alkyl Acrylates and Acrylic Acid, Nitro Cellulose and Vinyl Chloride)

Waxes: Petroleum Waxes (such as, but not limited to: Paraffin Wax, Microcrystalline Wax), Vegetable Waxes (such as, but not limited to: Carnauba Wax), Animal Waxes (such as, but not limited to: Lanolin), Synthetic Waxes (such as, but not limited to: Polyethylene Wax, Polypropylene Wax)

Fatty Acid Metal Soaps: Metal Stearates (such as, but not limited to: Magnesium Stearate, Zinc Stearate), Calcium Ricinolate

Long Chain Alkyl Derivatives: Fatty Ester Synthetic Waxes (such as, but not limited to: Diethylene Glycol Monostearate, Hydrogenated Castor Oil), Fatty Acids (such as, but not limited to: Steric Acid, Oleic Acid), Fatty Amines (such as, but not limited to: EthyleneBis (Stearamide), Oleyl Palmitamide)

Natural Products: Cellulose Derivatives (such as, but not limited to: Cellophane, Cellulose Acetate), Polysaccharides (such as, but not limited to: Sodium Alginate)

Inorganic Materials: Silicates (such as, but not limited to: Talc), Clay (such as, but not limited to: Kaolin, Mica), Silica, Graphite

Synthetic Polymers: Silicones (such as, but not limited to: PolyDimethylsiloxane, PolyAlkylmerthyl Siloxane), Fluorocarbons (such as, but not limited to: PolyTetraFluoroethylene, Poly(Fluoroacrylates)), Fluoro Polmers (such as, but not limited to: Poly(Fluoroethers)), Polyolefins (such as, but not limited to: Polyethylene, Polypropylene), Polyvinyl Alcohol

Fluorinated Compounds: Fluorinated Fatty Acids and Alcohols (such as, but not limited to: Perfluorolauric Acid)

Vinyl Acrylic Copolymers, Acrylic Polymers and Copolymers, Polyvinyl Acetate Polymers and Copolymers, Styrene Acrylic Polymers and Copolymers, Polyurethane Dispersions

Labels, sheets, or tapes back (back side of the substrate) break away coating (e.g., 101, FIG. 1A):

Solvent-Based or Water-Based: Vinyl Acrylic Copolymers, Acrylic Polymers and Copolymers, Polyvinyl Acetate Polymers and Copolymers, Styrene Acrylic Polymers and Copolymers, Polyurethane Dispersions. Also including combinations of the above-mentioned Polymers and Dispersions

(Ideally, but not limited to the final product having a Glass Transition Temperature (Tg) in the range of −20 to +20 Degrees Celsius)

Labels, sheets, or tapes back (back side of the substrate) adhesive coating (e.g. 105, FIG. 1A):

Solvent-Based or Water-Based, Very Low Peel Adhesion to Permanent Peel Adhesion Pressure Sensitive Adhesives consisting of, but not limited to: Vinyl Acrylic Copolymers, Acrylic Polymers and Copolymers, Polyvinyl Acetate Polymers and Copolymers, Ethylene Vinyl Acetate, Styrene Acrylic Polymers and Copolymers, Polyurethane Dispersions. Also including combinations of the above-mentioned Polymers and Dispersions. (NOTE: Common Acrylic Monomers used to produce the polymers are Ethyl Acrylate, Butyl Acrylate and Ethylhexyl Acrylate, but not limited to. Often blends of all three monomers are copolymerized or used in combination with other monomers and copolymerized.)

Solvent-Based or Water-Based, Very Low Peel Adhesion to Permanent Peel Adhesion Pressure Sensitive Adhesives consisting of, but not limited to: Tree sap, Beeswax, Tar, Resin, Animal Protein, Casein, Starch/Dextrin, Polychloroprene and Natural Rubber Latex or Synthetic Rubber (elastomers) (such as Styrene-Butadiene Rubber or Polyurethane). Polymers which are Soluble Thermoplastics, Elastomers or Polymer Dispersions (latices) and Cross-linked Elastomers. Dispersed Polymer (latex) particles with a diameter in the range of 50-100,000 nm, but not limited to.

Also, there can be UV Curable Pressure Sensitive Adhesives, UV Curable Silicone Pressure Sensitive Adhesives, Thermal Cured Silicone Pressure Sensitive Adhesives, UV/EB Curable Pressure Sensitive Adhesives, EB Curable Pressure Sensitive Adhesives, Hot Melt Adhesives, and/or Cold Seal Adhesives.

Liners and peel areas, strips, etc.—There can be peel sections (e.g., peel areas or strips) free of layers under the substrate, such peel strips on tapes or labels for easy removal of liners to expose the adhesive for application to a surface, where the tapes, sheets, labels, etc. are supplied as a linered product.

Exemplary adhesive patterns—The adhesive can be patterned. Exemplary suitable patterns include stripes, dots, circles, blocks, shapes, designs, logos, arrows and full coverage. Any suitable pattern can be used to apply the breakaway coating and adhesive to allow for, for example, logos—company branding (patterns of their company logos); alert and caution symbols—yield, stop, danger, etc. Patterns can also be used to allow the adhesive coated label (product) to pass through a printer easier than a full coverage adhesive pattern. Patterns can also help in the cutting process of the breakaway adhesive coated substrate (roll stock) after the printing process, such as for cash register receipts. By patterning the adhesive, the cutting knife can have less area or no area of adhesive to cut through.

### Examples

### Exemplary Application for a Fast Food Sale Setting

In an exemplary fast food application, the breakaway adhesive coating system of the Application can be used, for example, to seal a bag and/or a box of food to be delivered in a bag.

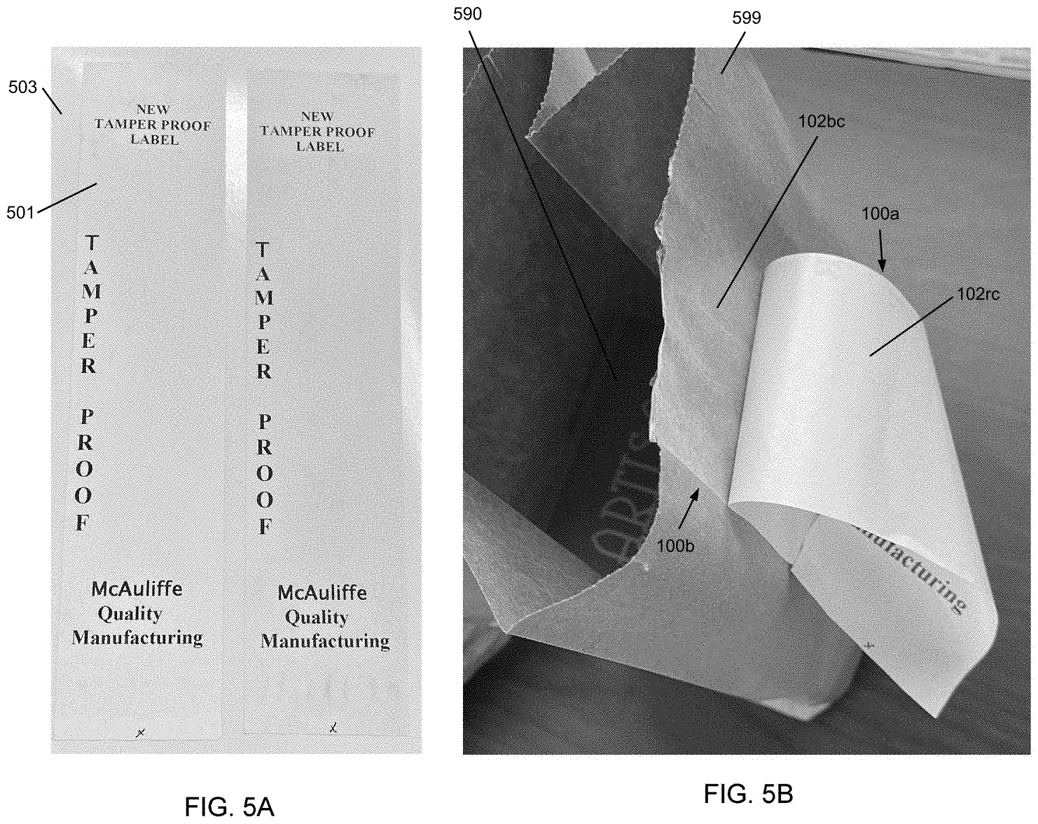

FIG. 5A is a drawing of an exemplary printed tape, such as a register tape. As shown for this demonstration example, the point of sale tape 501 has been printed, and stored on a removable liner 503. (In practice, there could be a linerless tape used out of the printer, or a linered tape out of the printer, where the liner is removed at time of use). The point of sale tape 501 was applied to a food delivery paper bag.

FIG. 5B is a drawing of the paper bag 599, where on opening the bag (either the end user consumer, or an intermediate tamper situation (e.g., a hungry delivery driver), the combined top part 100a has separated from the combined bottom part 100b. Now exposed and visible are the release coating lower surface 102rc and the breakaway coating top surface 102bc. Note that substantially all of the combined bottom part 100b remains on the substrate, here the surface of the paper bag 599.

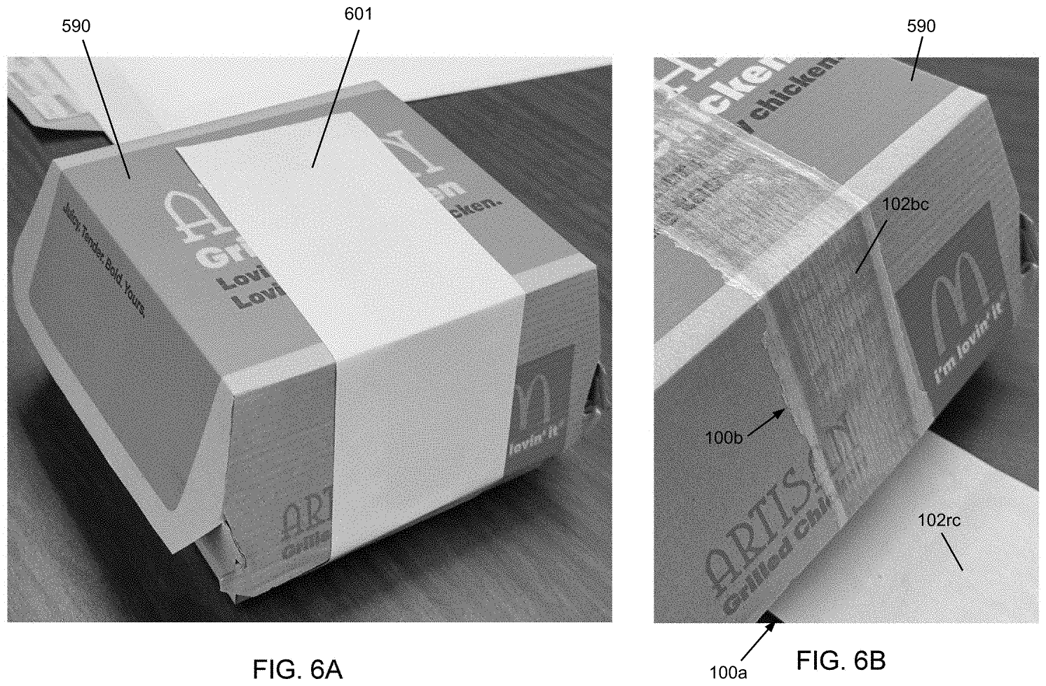

FIG. 6A is a drawing showing an exemplary food box 590 secured closed by a tape or label 601 of the new breakaway adhesive coating system. FIG. 6B is a drawing showing separation on opening between the combined top part 100a has separated from the combined bottom part 100b. Now exposed and visible are the release coating lower surface 102rc and the breakaway coating top surface 102bc. In this example, the breakaway coating 101 and/or the breakaway coating top surface 102bc includes a red color to further show affirmative evidence of the one-time separation of the combined top part 100a has separated from the combined bottom part 100b.

Either, or both of the release coating 103 and/or the breakaway coating 101 can include one or more colors (e.g., FIG. 6B).

Either, or both of the release coating 103 and/or the breakaway coating 101 can include text (e.g., “VOID”, “Tampered”, etc.) and/or images which become visible following the one-time separation of the combined top part 100a and the combined bottom part 100b.

We have realized and described hereinabove, a new breakaway film of coating system, as distinguished from a second substrate that breaks away. The film of coating breaks away from the substrate, and the substrate breaks away from the film of coating after it has been applied to a surface including the skin on ones fingers.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A breakaway adhesive coating system comprising:
a substrate having a first substrate surface and a second substrate surface;
a release coating disposed over at least a portion of and bonded to said second substrate surface;
a breakaway coating disposed over a release coating surface opposite to said second substrate surface, said breakaway coating bonded to said release coating; and
an adhesive layer disposed over a breakaway coating surface opposite to said release coating, said adhesive layer bonded to said breakaway coating.

2. The breakaway adhesive coating system of claim 1, wherein after said adhesive layer is affixed to a surface, a removal force applied to said breakaway adhesive coating system causes a bond between said release coating and said breakaway coating to break, wherein a first combination of said substrate and said release coating pull free of a second combination of said breakaway coating and said adhesive layer which remain affixed to the surface.

3. The breakaway adhesive coating system of claim 2, wherein following separation of said first combination of said substrate and said release coating and said second combination of said breakaway coating and said adhesive layer, both exposed surfaces of said release coating and said breakaway coating have substantially no tackiness.

4. The breakaway adhesive coating system of claim 1, wherein said breakaway adhesive coating system comprises a label.

5. The breakaway adhesive coating system of claim 1, wherein said breakaway adhesive coating system comprises a sheet.

6. The breakaway adhesive coating system of claim 1, wherein said breakaway adhesive coating system comprises a tape.

7. The breakaway adhesive coating system of claim 6, wherein said tape comprises a rolled linered tape.

8. The breakaway adhesive coating system of claim 6, wherein said tape comprises a rolled linerless tape.

9. The breakaway adhesive coating system of claim 6, wherein said tape comprises a point of sale register tape.

10. The breakaway adhesive coating system of claim 1, further comprising one or more print layers disposed on said first substrate surface.

11. The breakaway adhesive coating system of claim 10, wherein at least one print layer comprises a thermosensitive print layer.

12. The breakaway adhesive coating system of claim 1, wherein said substrate comprises a paper or a film.

13. The breakaway adhesive coating system of claim 1, wherein said release coating comprises a vinyl acrylic copolymer emulsion.

14. The breakaway adhesive coating system of claim 1, wherein said breakaway coating comprises a styrene-acrylic emulsion.

15. The breakaway adhesive coating system of claim 1, wherein said adhesive layer comprises an acrylic emulsion.

16. The breakaway adhesive coating system of claim 1, wherein said adhesive layer comprises a dry adhesive.

17. The breakaway adhesive coating system of claim 1, wherein said dry adhesive comprises a moisture activated adhesive.

18. The breakaway adhesive coating system of claim 1, wherein during manufacture of the breakaway adhesive coating system, at least of one of said release coating or said breakaway coating is applied wet and a bond formed there between during drying.
